(19) United States
(12) Patent Application Publication
(10) Pub. No.: US 2009/0265276 A1
(43) Pub. Date: Oct. 22, 2009

(54) METHOD FOR AUTHORIZING AT LEAST ONE TRANSACTION BY A BANK SYSTEM

(75) Inventor: Oliver Jordan, Bietigheim-Bissingen (DE)

Correspondence Address: HARNESS, DICKEY & PIERCE, P.L.C., P.O. BOX 828, BLOOMFIELD HILLS, MI, 48303, US

(73) Assignee: WINCOR NIXDORF INTERNATIONAL GMBH, Paderborn (DE)

(21) Appl. No.: 12/520,006

(22) PCT Filed: Dec. 18, 2007
(86) PCT No.: PCT/EP07/64149

§ 371 Date: Jun. 18, 2009

(30) Foreign Application Priority Data
Dec. 18, 2006 (DE) 10 2006 059 731.1

(51) Int. Cl. G06Q 40/00

(52) U.S. Cl. 705/44

(57) ABSTRACT

The invention relates to a method and a system for authorizing at least one transaction by a bank system, wherein at least one client application handled by the bank system is connected to at least one server application outside the bank system. With the help of the client application, at least one transaction item provided for selection by the server application is selected. Furthermore, authorization of the transaction of at least one selected transaction item is requested during a bank application of the bank system. The transaction is authorized with the help of the bank application.

The invention relates to a method as well as a system for authorizing at least one transaction by a bank system. Known bank systems comprise central data processing systems and bank terminals, such as cash dispensers, the positions of which are distributed over a large area, for example nationwide or worldwide, located at positions which are highly frequented by customers. As a result thereof, many customers have an access possibility to these bank terminals. The individual bank terminals are connected via data lines to the central data processing systems of a bank system, in particular to servers and/or hosts. These central data processing systems administer and monitor the bank transactions performed via these bank terminals. It is desirable to use the infrastructure already existing as a result of the bank terminals and the data processing systems for further transactions in addition to the bank transactions, as a result whereof further applications for the existing bank terminals arise. For example, it is desirable to handle ticket sales or the ordering of goods or services with the aid of the bank terminals. By the possibility of being able to perform further transactions, thus at least one value added service is provided which goes beyond the mere handling of bank transactions.

A possible solution for providing the functions required for such value added services at the bank terminal consists in changing the device software of the bank terminal and/or of the central data processing systems. Depending on the requirement, relatively comprehensive changes to the software are necessary. Further, an influencing of the functions required for the bank transactions by the functions required for the value added services cannot be definitely ruled out. Rather, there is the risk that a manipulation of banking functions, in particular a hacker attack on a bank terminal, can then not be safely prevented. Further, given such a solution, the software of the operation terminal and/or the central data processing systems has to be adapted for each additional value added service and for each additional or amended function of an already integrated value added service. This is particularly necessary in order to, for example, integrate a shop offering goods and/or services into the bank system. In the case of the solution described, a proprietary time-consuming individual solution is necessary for the integration of a value added service.

Known electronic shop systems are provided to a user as web applications which output a user interface via the display unit of an application computer with the aid of a browser program, such as the Microsoft Internet Explorer, the Mozilla Firefox or the browser Opera, via which user interface a transaction can be completely processed. The transaction item is selected via the provided user interface with the aid of at least one input unit, payment and delivery are caused and a receipt can be printed out or stored. When transaction items such as vouchers, coupons, tickets or rights are bought, these vouchers, coupons, tickets and proofs of rights can be directly output via a printer. An alternative or additional sending of such transaction items in electronic form, for example via e-mail or MMS or SMS is possible. An authentication of the user is performed in such known shop systems via an application, the data entered by a user upon application in general not being verified in every detail.

The electronic shop systems offer, for example, a possibility that the user compiles a so-called basket with selected transaction items, which are to be processed as one transaction, i.e. are paid together and preferably are sent together. After compiling the basket, the user causes payment and prints out a receipt or the transaction item itself at a printer. The printing out of the transaction item is particularly possible in the case of tickets, vouchers, the proof of a transferred right and reservation confirmations. The operator of such an electronic shop system can however often not effectively protect himself/herself against false user information as well as abuse and fraud which are made possible as a result thereof.

It is the object of the invention to integrate transactions of value added services in a simple way into the infrastructure of existing bank systems.

This object is solved by a method having the features of claim 1 as well as by a system having the features of claim 15. Advantageous developments of the invention are given in the subclaims.

By a method for authorizing a transaction by a bank system having the features of claim 1, it is possible to directly select transaction items from the supply data provided via a network or via data lines and to then confirm the transaction by an authorization generated with the aid of the bank system. Selectable transaction items can, for example, be goods, services and rights, in particular goods that can be sent via mail order, printable tickets, coupons, vouchers and proofs for acquired rights. The invention is based on the recognition that the selection of the transaction items largely takes place without falling back on safety-relevant functions of the bank system as required for bank transactions, the transaction being authorized with the aid of the bank system, in particular with the aid of the devices and functions required by the bank system for authentication. As a result thereof, the safety functions of the bank system, in particular functions for the authentication of a user or a customer can be used for the authorization of the transaction. Abuse and fraud can thus be safely avoided.

In one development of the invention, the transaction is authorized and a money transaction for payment of the transaction item is automatically initiated. As a result thereof, it can be guaranteed that given an authorization of the transaction by a user, payment of the selected transaction item is caused as well. It is in particular possible that the money transaction is actually only caused after the selected transaction item has been delivered to the customer or after the customer has already received the transaction item and has confirmed receipt of the correct delivery. Thus, a trustee function can be provided by the bank application. The money transaction for payment of the transaction item is then actually only caused by the bank system after delivery and/or after receipt of the transaction item. Alternatively, a money transaction can be performed independent of the bank system in that, for example, the provider of the transaction item gets credit card information of the customer during the transaction so that the credit card account of the customer can be debited. Alternatively or additionally, the customer can cause the remittance directly via the bank system or by way of a remittance slip. For this purpose, the bank system can print out a remittance slip already provided with the bank details of the provider of the transaction item as well as an information for the identification of the transaction and the amount for payment of the transaction item, or provide a remittance form for online banking that is already filled in. Further, the bank system can automatically check before the authorization of the transaction whether the account of the customer is sufficiently covered for this transaction. If the account is not sufficiently covered, the bank system can automatically prevent the authorization of the transaction.

The server application can assign the selected transaction item to a transaction. Alternatively, the transaction item can also be assigned to the transaction with the aid of the client application. In both alternatives for assigning the transaction items, these can advantageously be assigned to the transaction with the aid of a basket.

Further, an identification information can be assigned to the transaction, which identification information can then be used during authorization for identification of the transaction. Further, the identification information can be used for assigning customer data as well as for assigning payments to the transaction. The identification information is used for the identification of the transaction. The identification information can be transferred from the client application to the bank application or from the server application to the bank application. As a result thereof, the identification information is available to the bank application and can serve to unambiguously assign the transaction of the client application and the server application, which transaction is authorized by the bank system. Alternatively, the identification information can also be transmitted from the server application to the bank application.

Further, via a bank terminal of the bank system an interaction for preparing the transaction as well as for authorizing the transaction can be performed. The interaction is preferably performed via an interactive user interface provided by the client application at the bank terminal. The client application is preferably a smart client application. Such a smart client application can, in particular, enable a dynamic surface design of the user interface, a dynamic sequence design and/or an internal network management. A smart client application is a program module which is locally executed by a data processing system and can be installed and updated fully automatically via a network, in particular the Internet or an intranet. The use of a smart client application enables a good runtime behavior and a high ease of use while at the same avoiding or reducing local installation problems, a combination of advantages of a classic desktop application and the known web applications being achieved.

The access to databases can be provided by the smart client application both via a local network as well as via web services. Alternatively, so-called thin clients can be used as well, the functions of which are substantially restricted to the input and output of information, preferably in providing a user interface.

In contrast to the thin client, a smart client can also be active when the data processing system is not connected to a network such as the Internet. To this end, the smart client in particular has so-called emergency routines which are, for example, provided by a software stack. This distinguishes the smart client from mere browser-based applications which cannot be executed when the respective data processing system providing the thin client is not connected to the network or the Internet. The smart client applications can, however, provide user interfaces in connection with browser program modules and can transfer data with the aid of services and protocols which are also used for the transfer of data for merely web-based applications. By means of the smart client applications, there is the possibility that the program data for providing the smart client applications can be output and updated by a central server in real time via a network. The smart client applications support multiple platforms and programming languages since they are based on so-called web services. The smart client applications can thus be executed by any arbitrary Web-capable data processing system which has a network connection, preferably an Internet connection, including desktop computers, workstations, notebooks, template PCs and PDAs (personal digital assistants).

The invention can, however, be realized with different known client applications. By means of the invention a central configuration, application provision and application control of the Web-capable client application can take place. As a result thereof, by the client application a remote presentation layer, in particular for providing a shop system, can be provided which is separated from the further application and integration layers of the bank system. As a result thereof, necessary safety regulations can also be complied with when web technologies for applications and for the communication are used in order to, for example, provide a shop system. Thus, by the client an area is generated which is separate from the safety-relevant areas of the bank application and in which then the web applications such as Internet portals and shop systems can be implemented. This separate area is thus a safe decentralized container for the integration of web applications in bank systems, in particular for the integration on self-service bank terminals. The bank system is used for payment and for authorization of the user, as a result whereof a high degree of safety against abuse and fraud for both the user as well as for the shop operator or provider can be achieved.

In an advantageous development of the invention the server application can provide a shop system, via which several transaction items are offered. These transaction items can be selected via the client application of the bank system. The transaction items can preferably comprise at least one ticket, in particular an admission ticket, a train ticket, a flight ticket, a bus ticket or a ticket for the public local transport, a piece of goods, a service, a voucher, a stamp, a booking and/or a right, and by way of the selection of the transaction item and the authorization a reservation, a purchase or an offer to purchase is made. Further, several client applications can be provided from which one client application can be selected via the bank system, in particular via the bank terminal. At least one server application can be assigned to at least one of these client applications. It is also possible that several server applications are assigned to one client application, one server application then being preferably selectable with the aid of the client application.

Via the bank system and/or the client application a server application can be selected from several server applications, preferably one shop system being provided by each server application. The at least one client application and the at least one server application are connected to one another via at least one data connection, the data connection being in particular a secure data connection via a local network, a wide area network (WAN), a global network and/or a telephone network. Such a secure data connection can, in particular, be a data connection of a virtual private network (VPN).

A second aspect of the invention relates to a system for the authorization of at least one transaction by a bank system. The bank system executes program data of at least one client application. The client application in particular provides functions for the preparation of at least one transaction. The system comprises at least one server application outside the bank system, the client application and the server application being connected to one another via a data line, preferably a secure network connection. The server application provides at least one transaction item for selection, which transaction item can be selected with the aid of the client application. The server application or the client application generate an identification information for the identification of the transaction of at least one selected transaction item and/or of the transaction item, and transfers this identification information to a bank application of the bank system. The bank application authorizes the transaction in connection with the identification information.

What is achieved by such a system is that the bank system cannot only be used for classic bank applications and bank transactions but that, with the aid of the bank system, further transactions can be performed in addition to bank transactions. As a result thereof, value added services can be provided in a simple way. For these value added services then every cash dispenser released for this purpose or every further self-service terminal of a bank system released for this purpose can be used.

The influencing of the bank system itself and of the bank application is restricted to a minimum given the invention so that in particular safety-relevant programs of the bank system do not have to be changed for the implementation of the value added services. The existing safety measures of the bank system, in particular the functions of the bank system for the authentication of a user can, however, be used in order to authorize the transaction by the bank application in connection with the identification information. In doing so, a release information can be transferred from the bank application to the client application or directly to the server application. When the identification information is available to the bank application, then it can assign the identification information to the release information. Further, an amount to be paid can be authorized by the bank system and can be assigned to the transaction, in particular the identification information of the transaction. Alternatively, an identification information on the authorization information transmitted by the bank system for a transaction currently prepared with the aid of the client application can be assigned to the client application.

Transaction items in the sense of the invention are both stationary and movable items as well as immaterial items such as rights, reservations, clearing numbers and contracts on services.

The invention is particularly suitable for being realized at least partly with the aid of a computer program product (software) which can be distributed in a data file on a data carrier such as a disk, CD-ROM, or DVD or in a data file via a data or communication network as a computer program product for a data processing system. Such and comparable computer program products or program elements are embodiments of the invention. The inventive sequence can be run on a computer, in a control unit, in a cash system, in a bank terminal and/or a cash dispenser, which are each connected to further data processing systems via data lines and/or via a network. Suitable control units and/or data processing systems which are in particular realized as computers or microcontrollers and with the aid of which the invention is implemented, can comprise further technical devices known per se such as input means (keyboard, mouse, touch screen), at least one microprocessor, at least one data and/or control bus, at least one display device (monitor, display) as well as at least one main memory, one hard-disk memory, one flash memory and/or one network card.

Further embodiments and advantages of the invention result from the following preferred embodiments described in connection with the Figures.

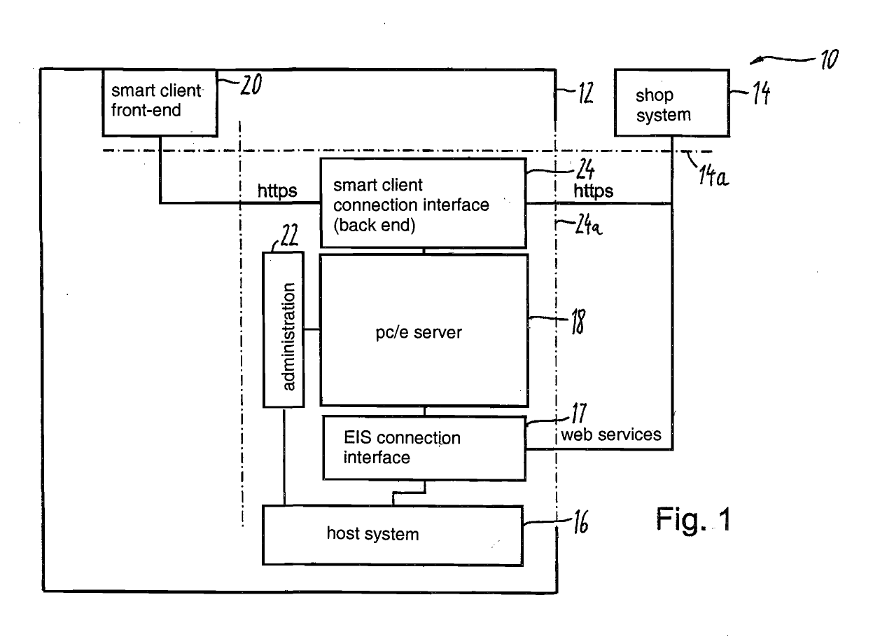

FIG. 1 shows a schematic illustration of components of a bank system and a shop system.

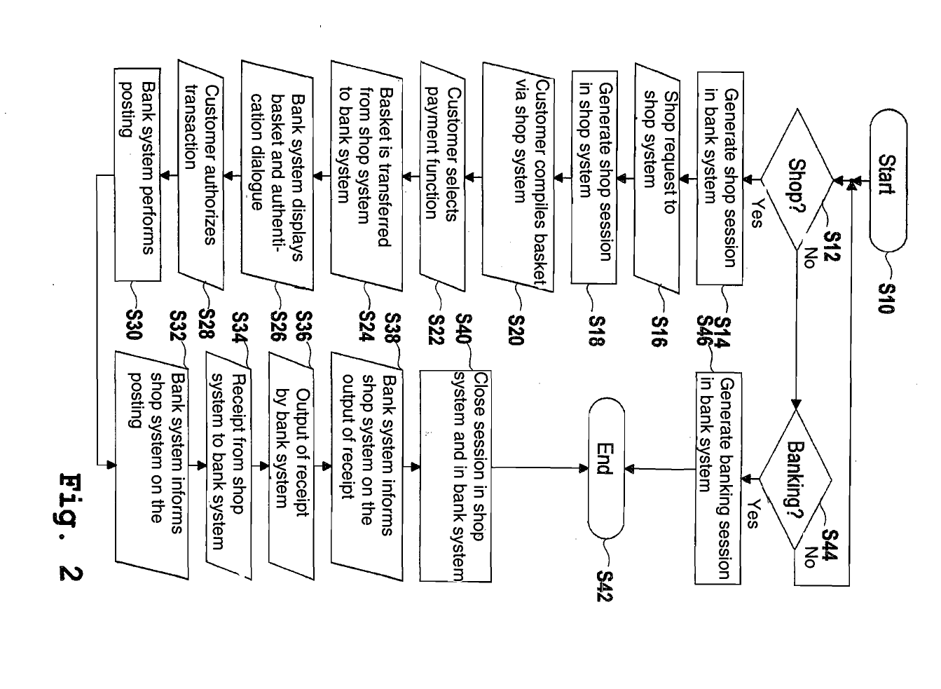

FIG. 2 is a flowchart for performing a shop transaction via a bank terminal of the bank system with the aid of the arrangement according to FIG. 1.

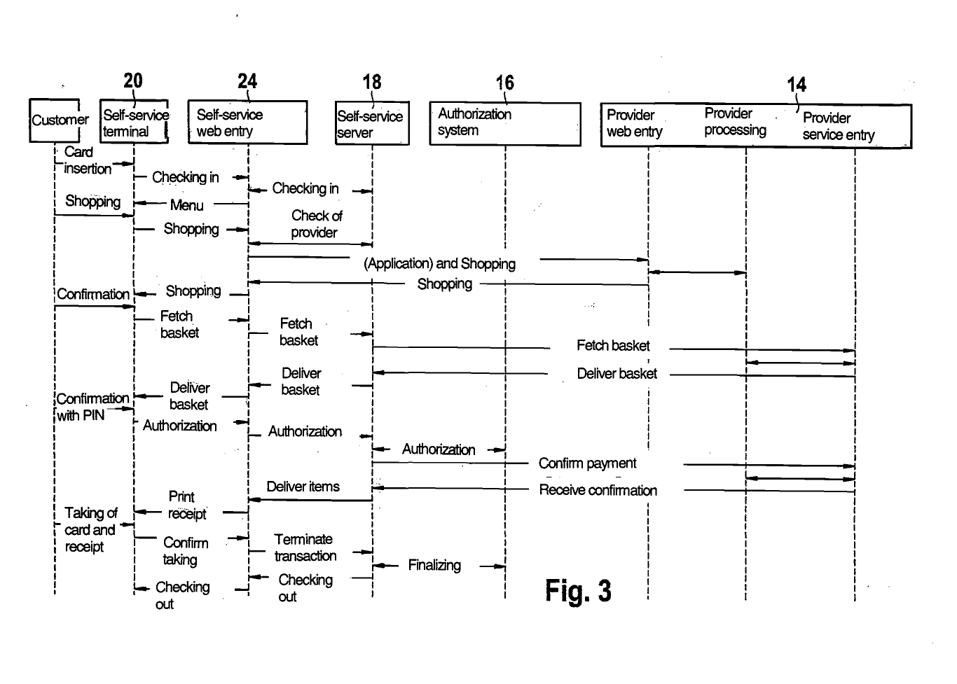

FIG. 3 is an illustration of the information exchange between the components of the arrangement of FIG. 1 for providing a shop system via the bank terminal of the bank system.

In FIG. 1, an arrangement 10 with components of a bank system 12 and with a shop system 14 is schematically illustrated, the shop system 14 being integrated into the bank system 12 as a value added service. As a result thereof, user can prepare transactions with the shop system 14 via the bank system 12 and authorize these transactions with the aid of the bank system 12. The bank system 12 has a host system 16, which is a so-called back-end for bank applications and with the aid of which bank transactions are monitored and registered. The host system 16 is connected via an EIS connection interface 17 (Enterprise Information System) to a server 18 for data exchange. Further, the host system 16 is connected to the server 18 via an administration connection 22. Further, the bank system 12 has a smart client connection interface 24, which is connected via a data line to at least one remotely arranged self-service terminal 20. The server 18 is a link between the bank transactions that can be performed via the self-service terminals 20. The self-service terminal 20 is, for example, a cash dispenser and has input and output units suitable for interaction. The self-service terminal 20 has a data processing system which executes a smart client application program, by means of which the self-service terminal 20 forms a so-called smart client front-end.

The smart client front-end, i.e. the self-service terminal 20 is connected to a smart client connection interface 24 of the bank system 12 via a secure data connection, preferably with the aid of the https protocol. The data connection between the smart client connection interface 24 and the self-service terminal 20 runs over a data network, preferably a wide area network such as the Internet, one system boundary being provided each between the smart client connection interface 24 and the network as well as between the self-service terminal 20 and the network. At each of the system boundaries 24 preferably a firewall is provided in order to prevent unauthorized access to the smart client connection interface 24 or the self-service terminal 20.

The shop system 14 provides a sequence control for a shop application, preferably via a webserver provided by the shop system 14. The shop system 14 is connected to the smart client connection interface 24 via a secure data connection, preferably with the aid of the https protocol, and provides via this connection preferably so-called web services. This connection can likewise be established via a wide area network, such as the Internet. The shop system 14 has a system boundary 14a to the network, and the smart client connection interface 24 likewise has a system boundary 24a to this wide area network. At each of these system boundaries, a firewall can be provided. Alternatively or additionally, the shop system 14 can be connected to the EIS connection interface 17 via a data line, services being provided by the shop system 14 to the EIS connection interface 17 via this data line, which services are also referred to as web services. The data connection between the shop system 14 and the EIS connection interface 17 is preferably a secure data connection via a wide area network, such as the Internet, a firewall being provided at each of the system boundaries 14a, 24a between the shop system 14 and this network as well as between the EIS connection interface 17 and the network. The server 18 is a link between the shop system 14 and the self-service terminal 20.

In FIG. 2, a flowchart for performing a so-called non-banking transaction with the aid of the arrangement 10 according to FIG. 1 is illustrated. This non-banking transaction is performed via a value added service which can be provided via the self-service terminal 20 according to FIG. 1 and can be used by customers thereat. Identical elements have identical reference signs.

The sequence for performing the non-banking transaction is started in step S10. Subsequently, in step S12 it is determined via a user input whether the shop system 14 has been selected. If this is the case, then in step S14, a shop session is generated in the server 18 of the bank system 12. The bank system 12 generates a request to the shop system 14 to provide a shop session. Thereupon, the shop system 14 generates a shop session in step S18 so that the user (customer) can compile in step S20 via the self-service terminal 20 a basket via a user interface provided by the shop system 14, preferably a web-based user interface. After compiling the basket, the user selects a payment function in step S22, which is offered to him/her via the self-service terminal 20. This payment function can be activated both via the smart client as well as via a further function of the self-service terminal 20 independent of the smart client.

Thereafter, the shop system 14 transfers the basket itself or an identification information which is assigned to the basket or to the transaction relating to the basket to the bank system 12. The bank system 12 displays the basket or the identification information and outputs an authentication dialog for authentication of the user. Via this authentication dialog, the user is authenticated by means of authentication means commonly used for bank transactions, such as a payment card and a PIN. Further authentication means which are common in bank systems 12 such as the detection of biometric features can be used alternatively or additionally. Alternatively, the authentication dialog can also be implemented immediately after the start of the sequence in step S10 or at an arbitrary position after the selection of the shop 14 in step S12.

Subsequently, an authorization dialog for authorizing the transaction or the purchase is output in step S28, in which the user has to confirm the transaction in order to authorize the transaction. After the authorization by means of the confirmation in step S28, the bank system 12 posts the amount necessary for the transaction from an account of the user to an account of the shop provider. Alternatively, the amount can likewise be posted onto a trust account of a bank, the bank then acting as a trustee. The accounts can be bank accounts, credit card accounts or offset accounts of other providers.

Subsequently, in step S32 the shop system 14 is informed by the bank system 12 that the posting has been carried out. In step S34, then a receipt is transferred from the shop system 14 to the bank system 12, which is then output in step S36 by the self-service terminal 20 of the bank system 12. The bank system 12 subsequently informs the shop system 14 in step S38 about the output of the receipt. Thus, the transaction is terminated, and in step S40 the session in the shop system 14 and the session in the bank system 12 are closed. Thereafter, the sequence is ended in step S42.

If in step S12, the non-banking transaction of the value added service provided by the shop system 14 is not selected, then it is checked in step S44 whether a bank service, i.e. a banking transaction, is desired. If this is not the case, then the sequence is branched back to step S12. If it is determined in step S44 that a bank service has been selected by the user of the self-service terminal 20, a banking session is generated in the bank system 12, an interaction via the self-service terminal 20 being provided which enables that bank services are implemented. Subsequently, the sequence is ended in step S42.

The shop system 14 is preferably based on web technology, so-called web services being provided. By implementing the sequence illustrated in FIG. 2, a transaction scheme is given that controls the important transfer from the selection phase (shopping phase), in which the selection of the transaction item takes place and which is performed by a communication between the self-service terminal 20 and the shop system 14, to the authorization and payment phase. This guarantees a secure communication of the involved components 14, 18, 20, 24. The necessary procedure can in particular be defined in a protocol which controls the transfer from the shopping phase into the authorization and payment phase. In the form as described, such a protocol is abstract enough in order to be used for different shop systems 14 and for different other value added services as well as concrete enough in order to meet the high requirements on transparency and safety of the operation as well. In particular, with the aid of such a protocol, so-called tokens for ensuring individual sequence steps are determined. These tokens, which serve as operators, are generated by individual components of the arrangement 10 during the transaction and are exchanged between the components. The tokens are always only known to the communicating components. The following tokens can, for example, be generated for the sequence described:
1. ShopSessionCode: identifies the shop session in the server 18
2. ShopSessionID: identifies the shop session in the shop system 14
3. Server-SessionID:identifies the customer session in the smart client connection interface 24 (back-end)

The ShopSessionCode is at first only known to the server 18 and the shop system 14. The ShopSessionID is only known to the smart client front-end of the self-service terminal 20, the smart client connection interface 24 (back-end) and the shop system 14. The Server-SessionID is only known to the smart client front-end of the self-service terminal 20 and the smart client connection interface 24 (back-end). A transaction can only be authorized when all tokens are altogether present. The Server-SessionID is only transmitted to the shop system 14 after authorization and after printout of the receipt. The smart client application program of the self-service terminal 20 has in particular the function to control and monitor the sequence of the shop application in a specific application framework. In the smart client application program an authorization dialog for authorizing a transaction with the shop system 14 is integrated. Further, safety data in the form of the ShopSessionID are managed. Moreover, the smart client application program of the self-service terminal 20 provides a cancellation function for the cancellation of a transaction, in particular a transaction that has already been authorized. The smart client connection interface 24 which serves as a back-end for the smart client application program of the self-service terminal 20, in particular manages the shop session, as well as the Server-Session ID and provides a protocol interface to the shop system 14.

For implementation of the inventive sequence, in particular the services of the server 18 are adapted in order to provide the required functions. In particular, the server 18 is adapted such that a configuration and a management of several different shop systems 14 as well as their providers are possible. Further, a function for the distribution of the transaction data such as information on a basket with items selected for a transaction is provided by the server 18. Further, an integrated function for the authorization of a transaction is provided, and the required safety data, in particular the ShopSessionCode is managed. Further, the course of the transaction is documented with the aid of the server 18.

In FIG. 3, the exchange of important information between components of the arrangement 10 according to FIG. 1 for performing a non-banking operation is schematically illustrated as an example. In the present embodiment, a customer, the smart client application of the self-service terminal 20, the smart client connection interface 24 referred to as a self-service web entry in FIG. 3, the server 18, the shop system 14 and the host system 16 as the authorization system interact for performing the non-banking operation. The shop system 14 has the components web entry, processing and service entry.

The customer inserts a bank card, in particular an EC and/or credit card which is, for example, a magnetic strip card and/or a chip card, into the read device of the self-service terminal 20. Thereafter, the self-service terminal 20 generates an application information and transfers the same to the self-service web entry 24 which further transfers the application information to the server 18. The server 18 generates a feedback and transfers it to the self-service web entry 24. The self-service web entry 24 then generates data for the provision of a user interface and transfers the data to the self-service terminal 20.

Via this self-service terminal 20, the customer selects the menu item “shopping”. The self-service terminal 20 generates a corresponding information and transfers it to the self-service web entry 24 which forwards this information to the server 18. The server 18 checks whether the selection generated by the customer is authorized for the respective customer, i.e. whether the customer may perform the selected non-banking operation and may access in the present embodiment the selected value added service of a shop provider. Further, the server 18 checks whether the provider of the selected value added service is a provider who is currently authorized. If this is the case, then the server 18 transfers the request “shopping” of the customer together with a confirmation to the self-service web entry 24 which transfers an application information to the shop system 14. The shop system 14 registers the application and generates a confirmation of the application as well as information on selectable transaction items via the self-service web entry 24 to the self-service terminal 20. The transaction items selectable via the shop system 14 are output to the customer preferably via a graphical user interface for selection via the self-service terminal 20. By means of a further data exchange between the self-service terminal 20 and the shop system 14, the customer selects the desired transaction items. The selection of the transaction items by the customer is registered by the shop system 14 and assigned to the customer or the shopping operation. This assignment is effected in the shop system 14 preferably with the aid of a basket. After the selection of the transaction items, the customer confirms via an operator input at the self-service terminal 20 that he/she wishes to confirm the transaction for the selected transaction items. Thereafter, the self-service terminal 20 generates a request to transfer data with information on the transaction item assigned to the basket or transaction items assigned to the basket to the self-service terminal 20. This request is transferred via the self-service server 18 to the shop system 14. The request is processed by the service entry of the shop system 14 as well as in the shop system 14 by means of a further processing.

As a result, the service entry of the shop system 14 generates information on the transaction items assigned to the basket and transfers this information to the server 18. The information on the basket is transferred from the server 18 via the self-service web entry 24 to the self-service terminal 20 and is displayed to the customer via a user interface for confirmation of the transaction. For confirmation of the transaction, the customer enters a pin code and additionally or alternatively a further identification information for his/her authentication at the self-service terminal 20.

By entering the authentication information and/or by a further user entry of the customer at the self-service terminal 20, the customer confirms the transaction. As a result of this confirmation, the self-service terminal 20 generates an authorization information for authorizing the transaction, which authorization information is transferred from the self-service terminal 20 via the self-service web entry 24 and the server 18 to the authorization system 16. The host system 16 registers the authorization of the transaction and causes payment of the transaction items present in the basket. Further, the host system 16 confirms the authorization and the associated payment and transfers a corresponding information to the server 18.

The server 18 then generates a confirmation of the payment of the transaction items and transfers the confirmation to the service entry of the shop system 14. This information is further processed in the shop system 14 by a processing unit which generates an information that the shop system 14 has received the confirmation of payment. This information is transferred to the server 18. The server 18 then generates an information that the items are delivered and transfers this information to the self-service web entry 24. On the basis of this information, the self-service web entry 24 generates data for the printout of a receipt on the transaction performed, which data are transferred to the self-service terminal 20. The printout of the receipt can be caused automatically or, alternatively, only if desired by the customer. Thereafter, the customer is requested to take the receipt and the card. The self-service terminal 20 confirms the taking of the receipt as well as of the card and transfers this information to the self-service web entry 24. The self-service web entry 24 then causes the server 18 to complete the transaction.

The server 18 then transfers the information to the authorization system 16 to finalize the transaction, i.e. to complete the transaction operation. The host system 16 confirms the completion of the transaction and transfers a corresponding information to the server 18. The server 18 then generates an information that the customer has been checked out at the host system 16, which information is transferred via the self-service web entry 24 to the self-service terminal 20. Thus, the operation is completed.

As explained in connection with FIGS. 1 and 2, the self-service terminal 20 executes a self-service client application. In other embodiments, the authorization system provided by the host system 16 can also comprise additional or alternative components of the bank system with which an authorization of the transaction and the preferably necessary authentication of the customer are made possible. The provider system referred to as the shop system 14 can also comprise several shops, and the shop systems can in particular be offered by different providers. The provision of several shop systems is also referred to as a mall, which forms a portal for the selection of several shops of different providers. The web entry of the shop system 14 provides web services, in particular a web server for controlling the workflow and for providing a graphical user interface for offering and selecting transaction items. The service entry of the shop system 14 serves to control the transaction, in particular to exchange information for the authorization of the transaction.

The flowchart shown in FIG. 3 is only exemplary and can be adapted to the specific requirements. For example, the PIN and/or a further information for authentication of the customer can also be requested at an earlier point in time, in particular immediately after insertion of the bank card and the reading in of data of the bank card by the self-service terminal 20. Further, the bank card can also be inserted in the self-service terminal 20 only immediately before the authorization of the transaction. It is not the specific sequence of the illustrated information exchange between the individual components shown in FIG. 3 which is decisive but the basic interplay between the individual components involved in the transaction and the authorization of the transaction.

By the sequence illustrated and described in FIG. 2 and the information exchange (basically illustrated in FIG. 3) between those components of the arrangement 10 according to FIG. 1 which are important for the transaction, an advantageous embodiment of the invention is described, by which the value added service of a shop system 14 is integrated in a simple way into the infrastructure of a bank system 12 without safety-relevant structures of the bank system 12 having to be changed. The function scope of the shop system 14 or of other value added services can be integrated and the integration of additional value added services is possible in the same way. As a result thereof, a universal integration possibility for value added services is made possible, in the case of which an authorization of the transaction prepared by the value added service can be implemented with the aid of the bank system 12.

The invention is particularly suitable to be realized with the aid of computer software in bank terminals known per se, in particular in cash dispensers known per se as well as in self-service cash systems. The cash systems are then connected to the further components of the bank system 12 preferably in the same manner as the self-service terminal 20.

### LIST OF REFERENCE SIGNS

10 arrangement
12 bank system
14 shop system
16 host system
17 EIS connection interface
18 server
20 self-service terminal/smart client front-end
22 administration connection
24 smart client connection interface/smart client back-end
S10-S46 method steps
14a, 24a system boundary

1. A method for authorizing at least one transaction by a bank system,
in which at least one client application executed by the bank system is connected to at least one server application outside the bank system,
with the aid of the client application, at least one transaction item provided by the server application for selection is selected for the transaction,
an authorization of the transaction of the transaction item is requested from a bank application of the bank system,
and in which the transaction is authorized with the aid of the bank application.

2. The method according to claim 1, wherein an identification information for identifying the transaction, the transaction item and/or the user is transferred to the bank application, and an authorization of the transaction is requested, the transaction being authorized in connection with the identification information with the aid of the bank application.

3. The method according to claim 1, wherein the transaction is authorized and a money transaction for payment of the transaction item is automatically initiated.

4. The method according to claim 1, wherein the money transaction for payment of the transaction item is only initiated after delivery of the transaction item.

5. The method according to claim 1 claim 1, wherein a money transaction for payment of the transaction item is performed independent of the authorization of the transaction.

6. The method according to claim 1, wherein the selected transaction item is assigned to a transaction with the aid of the server application.

7. The method according to claim 1, wherein via a bank terminal of the bank system an interaction for the preparation of the transaction as well as for the authorization of the transaction is performed, the interaction preferably being performed via a user interface provided by the client application at the bank terminal.

8. The method according to claim 1, wherein the client application is a smart client application, preferably with a dynamic surface design, with a dynamic sequence design and/or with a internal network management.

9. The method according to claim 1, wherein the server application provides a shop system, via which a plurality of transaction items are offered which can be selected via the client application of the bank system, the transaction items preferably being a ticket, in particular an admission ticket, a train ticket, a flight ticket or a bus ticket, a piece of goods and/or a service, a reservation or a purchase or, respectively, an offer to purchase being made by the selection of the transaction item and the authorization.

10. The method according to claim 1, wherein via the bank system a client application is selected from several client applications, at least one server application being assigned to at least one client application.

11. The method according to claim 1, wherein via the bank system and/or the client application a server application is selected from several server applications, at least one shop system being provided by each server application.

12. The method according to claim 1, wherein the at least one client application and the at least one server application are connected to each other via at least one data connection.

13. The method according to claim 12, wherein the data connection is a secure data connection via a local network, a wide area network, a global network and/or a telephone network.

14. The method according to claim 1, wherein the identification information is transferred from the client application to the bank application or from the server application to the bank application.

15. A system for authorizing at least one transaction by a bank system, comprising
a bank system which executes at least one client application,
at least one server application outside the bank system, the client application and the server application being connected to each other,
the server application providing at least one transaction item for selection, which transaction item can be selected with the aid of the client application,
the server application or the client application requesting an authorization for authorizing the transaction of at least one selected transaction item and/or the transaction item at a bank application of the bank system, and transferring the authorization to this bank application,
and the authorization of the transaction being implemented with the aid of the bank application.

16. The system according to claim 15, claim 1, wherein the server application or the client application generates an identification information for identifying the transaction of at least one selected transaction item, the transaction item itself and/or a user, and transfers the identification information to the bank application.

17. A computer program product, comprising commands and data in encoded form which after loading of the program data cause a data processing system to perform and/or control a method according to claim 1.

18. A data carrier with program data of a computer program product according to claim 17.
